(19) United States
(12) Patent Application Publication
(10) Pub. No.: US 2008/0022118 A1
(43) Pub. Date: Jan. 24, 2008

(54) Information processing apparatus and control method thereof

(76) Inventor: Shinsuke Yato, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/731,937

(22) Filed: Apr. 2, 2007

(30) Foreign Application Priority Data
May 30, 2006 (JP) P2006-149739

(51) Int. Cl. H04K 1/00

(52) U.S. Cl. 713/183

(57) ABSTRACT

According to one embodiment, there is provided an information processing apparatus including: a status determining unit that determines whether or not the information processing apparatus is in a password input status under which allowing a user to input a password by a keyboard; a sound generating unit that generates an overlap sound to be overlapped with a tapping sound of the keyboard when the status determining unit determines that the information processing apparatus is in the password input status; and a sound output unit configured to externally output the overlap sound.

### CROSS-REFERENCE TO RELATED APPLICATIONS

This application is based upon and claims the benefit of priority from Japanese Patent Application No. 2006-149739, filed May 30, 2006, the entire contents of which are incorporated herein by reference.

### BACKGROUND

1. Field

One embodiment of the present invention relates to an information processing apparatus to which various sorts of data are inputted by a keyboard and a control method thereof.

2. Description of the Related Art

Security techniques such as authentication techniques are very important for information processing apparatuses. When authentication information such as a password is stolen by a third party, data stored in such information processing apparatuses may be abused by the third party to cause large damage.

Then, biological authentication techniques using fingerprints and pupils as well as authentication techniques using passwords have been developed and are practically utilized. For these biological authentication techniques, however, input devices exclusively designed for these biological techniques are necessarily required. Then, the authentication techniques that do not require specific input devices have been still widely used even at the present day.

In order for passwords to be hardly stolen by a third party, it is effective to use long and complex passwords. However, there are such risks that users may forget the long and complex passwords, or may erroneously enter the long and complex passwords.

To avoid the above-explained risks, Japanese Patent Application Publication (KOKAI) No. 10-283321 discloses a technique to generate musical scales according to respective keys of a keyboard. Then, for instance, desirable melodies may correspond to characters of passwords. As a result, even when long passwords are employed, the users hardly forget these long passwords, and also, erroneous entries of these long passwords may be avoided.

However, when the musical scales different from one another for each key are generated, there is another risk that sounds generated when a password is entered is heard by a third party near a user who enters this password, and the entered password may be stolen by this third party.

As a consequence, for example, Japanese Patent Application Publication (KOKAI) No. 2001-177638 discloses a technique to recognize a status in which users input passwords for a telephone, or the like capable of generating sound having different musical scales for every ten keys. Then, when it is recognized that such telephone is in the status, a function of generating the sound having the different musical scales for every ten keys is forcibly turned off.

Recently, a research report is presented in “Key board Acoustic Emanations Revisited”, Proceedings of the 12th ACM Conference on Computer and Communications Security, pages 373 to 382 (November 2005) showing that a tapped key of a keyboard can be discriminated in high probability from tapping sound itself of the keyboard, not but from the musical scales generated from the keyboard.

According to the research report, by analyzing the recorded tapping sound data of the keyboard, even when such a password is made of a character string at random, if tuning operations, or the like are repeatedly carried out in response to an environment, the following recognizing rates are achieved: 90% in maximum as to the 5-digit password; 77% in maximum as to the 8-digit password; and 69% in maximum as to the 10-digit password.

Assuming that such a technical idea is employed by persons with evil intent, passwords may be stolen from key tapping sound when these passwords are entered under very normal condition in information processing apparatuses such as personal computers which are used under very normal condition.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a system configuration of an information processing apparatus according to a first embodiment of the present invention;

FIG. 2 is an exemplary flow chart showing operations (control method) of the information processing apparatus according to the first embodiment;

FIG. 3 is an exemplary diagram showing a system configuration of an information processing apparatus according to a second embodiment of the present invention;

FIG. 4 is an exemplary diagram showing a system configuration of an information processing apparatus according to a third embodiment of the present invention; and

FIG. 5 is an exemplary flow chart showing operations (control method) of the information processing apparatus according to the third embodiment.

### DETAILED DESCRIPTION

Various embodiments according to the invention will be described hereinafter with reference to the accompanying drawings. In general, according to one embodiment of the invention, there is provided an information processing apparatus including: a status determining unit that determines whether or not the information processing apparatus is in a password input status under which allowing a user to input a password by a keyboard; a sound generating unit that generates an overlap sound to be overlapped with a tapping sound of the keyboard when the status determining unit determines that the information processing apparatus is in the password input status; and a sound output unit configured to externally output the overlap sound.

### First Embodiment

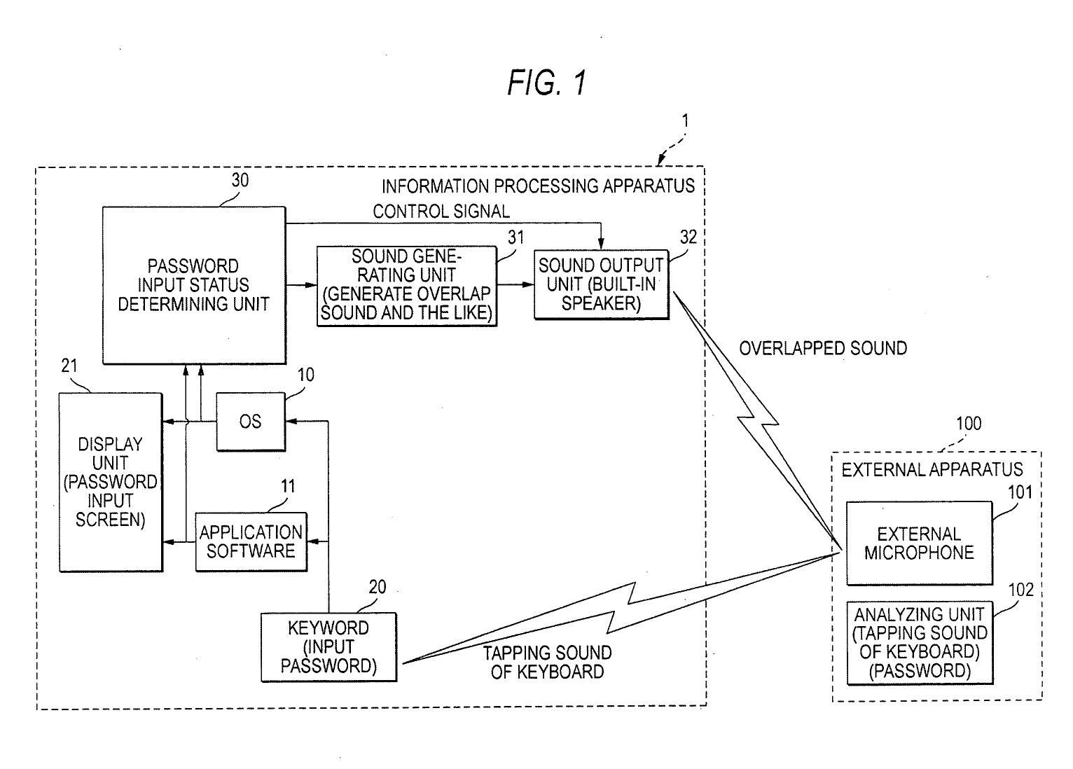

FIG. 1 is an exemplary diagram showing a system configuration of an information processing apparatus 1 according to a first embodiment.

The information processing apparatus 1 is, for example, a personal computer, and includes hardware such as a CPU and a memory, and software such as an Operating System (OS) and application software.

FIG. 1 shows a system configuration components, which relates to password input operations and is extracted from the respective components included in the information processing apparatus 1.

It should be noted that although an external apparatus 100 is shown in combination with the information processing apparatus 1 in FIG. 1, the external apparatus 100 is required only for explaining operations of the information processing apparatus 1, but is not included in the information processing apparatus 1.

The information processing apparatus 1 includes a keyboard 20, a display unit 21, and a sound output unit 32. The keyboard 20 inputs various sorts of data and passwords. The display unit 21 displays a screen used to enter the passwords in addition to displaying of various sorts of information as well as images. The sound output unit 32 outputs sound such as overlap sound outside the information processing apparatus 1.

Also, as the software, the information processing apparatus includes various sorts of application software 11, for example, an OS (Operating system) such as Windows®, word processing software, a web browser, and the like.

The information processing apparatus 1 is further includes a password input status determining unit 30 and a sound generating unit 31. Both the password input status determining unit 30 and the sound generating unit 31 are configured as, for example, one of utility software (that is, auxiliary software other than OS 10 and application software 11).

The external apparatus 100 includes an external microphone 101 and an analyzing unit 102. The external microphone 101 collects tapping sounds of the keyboard 20 of the information processing apparatus 1. The analyzing unit 102 stores and analyzes the collected tapping sounds in order to determine which key on the keyboard a user of the information processing apparatus 1 taps.

Although the function of the analyzing unit 102 does not directly relate to the present invention, for example, according to the technique disclosed in “Key board Acoustic Emanations Revisited”, Proceedings of the 12th ACM Conference on Computer and Communications Security, pages 373 to 382 (November 2005), even when a password is configured by mixing alphabetical numerals with one another at random, such a password may be detected in relatively high discrimination probability.

If the external apparatus 100 is utilized by a third party with evil intent, then this external apparatus 100 may be used as password stealing apparatus.

The information processing apparatus 1 according to the first embodiment may prevent stealing of a password. The sound output unit 32 actively generates sound (overlap sound) when a password is entered so as to achieve a disturbing effect by the generated sound, by which tapping sound generated from the keyboard 20 may be hardly analyzed.

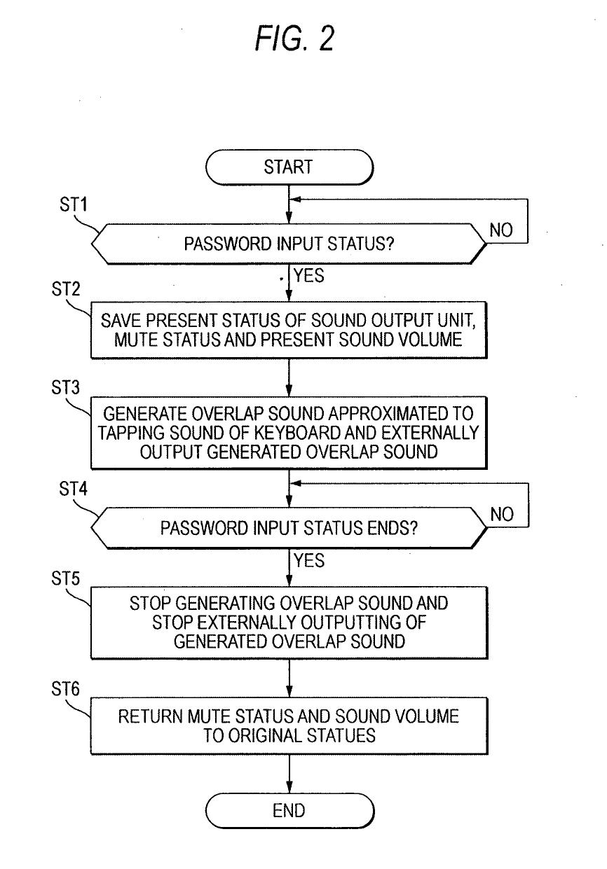

Referring to FIG. 1, operations (control method) of the information processing apparatus 1 will be described in accordance with a flow chart shown in FIG. 2.

In a block ST1, firstly, a determination is made as to whether or no the information processing apparatus 1 is in a password input status. Normally, the OS 10 such as Windows requests an entry of a password as authentication information of a user when the OS 10 starts (note that if OS 10 is set in different manner, then entry of password is skipped) At this time, the OS 10 instructs the display unit 21 to display thereon a password input-purpose screen. When the user enters the password and the authentication succeeds, the password input-purpose screen is closed.

In this first embodiment, such a status that the above-explained password input-purpose screen is being displayed is referred to as a password input status.

The password input status determining unit 30 determines as to whether or not the information processing apparatus 1 is in a password input status by monitoring display information of the password input-purpose screen outputted from the OS 10.

An entry of a password is required by not only the OS 10, but also various sorts of application software 11. For example, in word processing software, a password is attached to a formed document and then the formed document which is attached with the password may be saved. It is necessary to enter the correct password to open the document attached with the password. Also, in this case, the password input-purpose screen (window) is displayed on the display unit 21 when the password is entered.

Similarly, in this case, the password input status determining unit 30 determines as to whether or not the information processing apparatus 1 is in a password input status by monitoring display information of the password input-purpose screen outputted from the application software 11.

When the password input status determining unit 30 determines that the information processing apparatus 1 is in the password input status, the password input status determining unit 30 monitors the sound output unit 32. In the sound output unit 32, according to a user setting, or the like, the sound output may be turned off (mute). Also, when the sound output is turned on, a sound volume of the sound output unit 32 may be set. The password input status determining unit 30 monitors these statuses of the sound output unit 30 and saves these monitored statuses (block ST2).

Next, the password input status determining unit 30 instructs the sound generating unit 31 so as to generate overlap sound, and instructs the sound output unit 32 to externally output the overlap sound in a proper sound volume (block ST3).

In this case, the overlap sound may disturb an analyzing operation with respect to the tapping sound of the keyboard 20. For instance, this overlap sound is a noise-shaped sound whose frequency is overlapped with a part of a frequency range of the tapping sound of the keyboard 20 in order to disturb the frequency analyzing operation with respect to the tapping sound of the keyboard 20. Alternatively, quasi-tapping sound which is approximated to the tapping sound of the keyboard 20 may be generated at random irrespective of an actual keyboard operation. As explained above, since the quasi-tapping sound is overlapped with the actual tapping sound of the keyboard 20, the analyzing operation as to the actual tapping sound may be hardly carried out.

It should be understood that some users may have unpleasant feelings as to the generated overlap sound. In this case, pleasant sound such as music which may give pleasant feelings to persons is overlapped with such an overlap sound as noise or quasi-tapping sound, so that the unpleasant feelings given to the users may be relaxed.

The sound generating unit 31 generates both pleasant sound and overlap sound, and overlaps the generated pleasant sound with the overlap sound, and then, outputs the finally overlapped sound to the sound output unit 32.

While the overlapped sound is outputted, the password input status determining unit 30 also continuously monitors the password input status.

In a block ST4, when the password status determining unit 30 determines a termination of the password input status, the generation of the overlap sound is stopped, and the outputting operation of the overlap sound is stopped (ST5).

Thereafter, either the mute status or the sound volume saved in the block ST2 are set to the sound output unit 32, and then, the information processing apparatus 1 is returned to the original status (ST6).

According to the above configuration, the disturbance noise which covers the frequency ranges of the tapping sound or the sound approximated to the tapping sound is overlapped with the tapping sound of the keyboard 20. As a result, the tapping sound of the keyboard 20 may be hardly analyzed so as to prevent stealing of the password.

### Second Embodiment

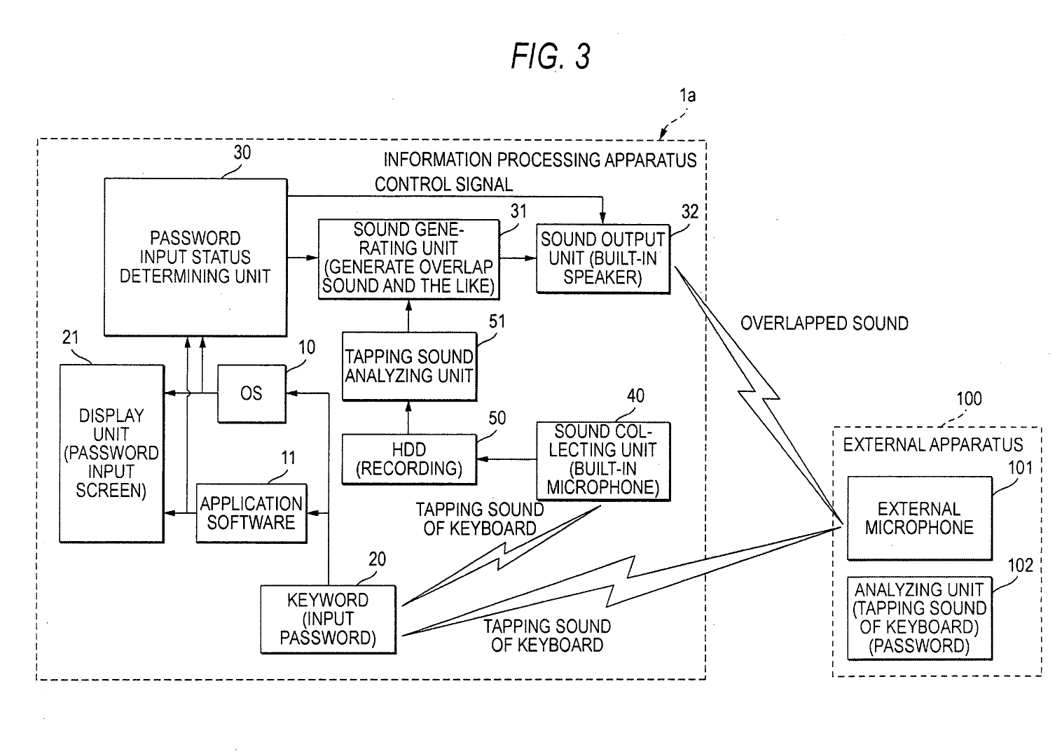

FIG. 3 is an exemplary diagram showing a system configuration of an information processing apparatus la according to a second embodiment.

As a different point from the first embodiment, the information processing apparatus la further includes a sound collecting unit (built-in type microphone) 40, an HDD (Hard Disk Drive) 50, and a tapping sound analyzing unit 51. The sound collecting unit 40 collects the tapping sound of the keyboard 20. The HDD 50 stores thereinto the collected tapping sound of the keyboard 20. The tapping sound analyzing unit 51 analyzes the tapping sound of the keyboard 20.

The tapping sound of the keyboard 20 subtly differs from one another depending on the sort of keyboard 20. Also, even in the same sort of keyboards 20, tapping sounds of these keyboards are different between each keyboard 20. The quasi-tapping sound as the overlapped sound according to the first embodiment is commonly generated irrespective of differences between each keyboard. As a consequence, there is a risk that a difference between the actual tapping sound of the keyboard 20 which has the individual difference and the quasi-tapping sound which is commonly generated is detected, and then, the overlapped sound of the quasi-tapping sound is removed, depending on an analysis made by the external apparatus 100.

In the second embodiment, the tapping sound generated from the own keyboard 20 is recorded, and then, such a quasi-tapping sound is generated by the sound generating unit 31, which is furthermore approximated to the tapping sound generated by the own keyboard 20 based on a result of the analysis obtained by previously analyzing the recorded tapping sound by the tapping sound analyzing unit 51.

As a consequence, there may be a low possibility that the quasi-tapping sound is detected to be removed due to the difference in the tapping sound caused by the sorts of keyboard 20, and the individual difference of the keyboards 20.

### Third Embodiment

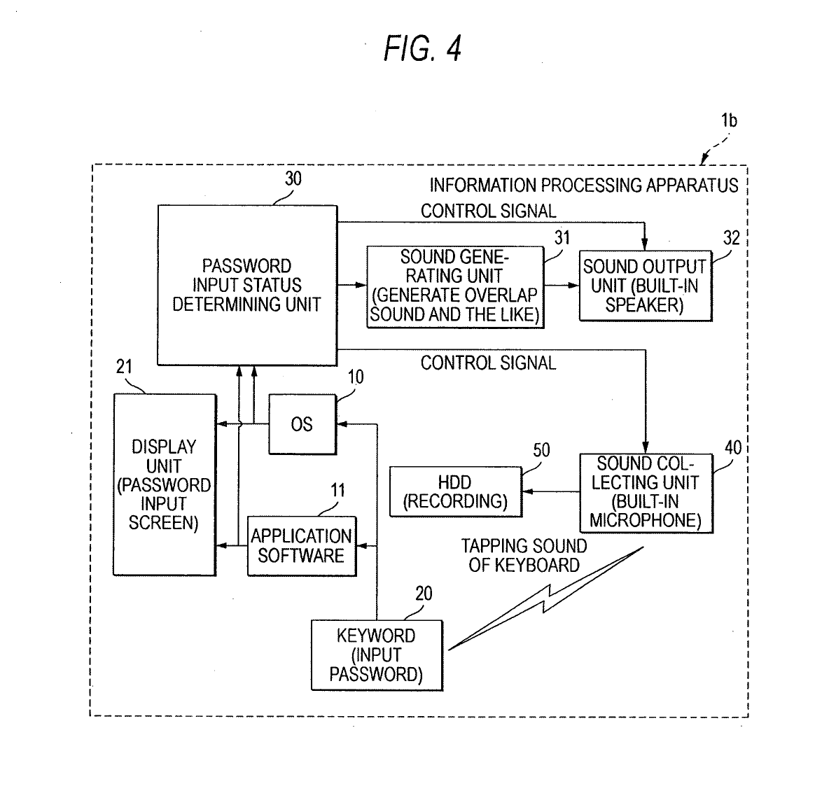

FIG. 4 is an exemplary diagram showing a system configuration of an information processing apparatus 1b according to a third embodiment.

The information processing apparatus 1 and 1a according to the first and second embodiments may prevent stealing of the password by collecting the tapping sound of the keyboard 20 using microphone installed outside these information processing apparatus 1 and 1a and analyzing the collected tapping sound.

In contrast, the information processing apparatus 1b according to the third embodiment may prevent stealing of the password based on information stored in the information processing apparatus 1b, which is stolen itself by a third party.

As shown in FIG. 4, most of the information processing apparatus 1b such as personal computers includes a sound collecting unit (built-in microphone) 40 and an HDD 50.

Normally, operations of the sound collecting unit 40 are set by a user. However, a user does not always recognize that the sound collecting unit 40 is turned on or off during the normal operation.

While the sound collecting unit 40 is turned on and the collected sound is recorded in the HDD 50, if the keyboard 20 is operated so as to enter the password, then the tapping sound of this keyboard 20 is recorded in the HDD 50.

As a consequence, there is such a risk that the tapping sound of the keyboard 20 stored in the HDD 50 is analyzed by the third party who has stolen the information processing apparatus 1b, so that the password may be stolen by the third party.

The information processing apparatus 1b according to third embodiment may be capable of avoiding this type of password stealing problem.

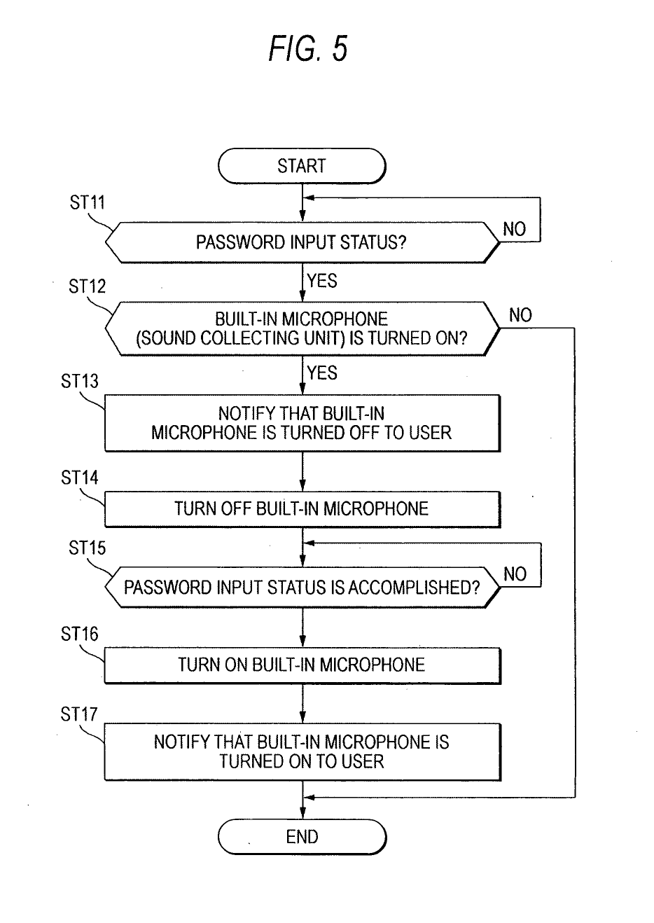

Referring to FIG. 4, operations (control method) of the information processing apparatus 1b according to the third embodiment will be described in accordance with a flow chart shown in FIG. 5.

In a block ST11, firstly, a determination is made as to whether or not the information processing apparatus 1b is in a password input status. This determination is carried out in the same method of the first embodiment.

When the password input status determining unit 30 determines that the information processing apparatus 1b is in the password input status, the password input status determining unit 30 monitors a status of the sound collecting unit 40 (block ST12). When the sound collecting unit 40 is turned off, since the tapping sound of the keyboard 20 is not recorded in the HDD 50, the operation process ends.

On the other hand, if the sound collecting unit 40 is turned on (“YES” in block ST12), then the password input status determining unit 30 notifies that the sound collecting unit (built-in microphone) 40 is turned off to the user (block ST13), and thereafter, sets the sound collecting unit 40 to be turned off (block ST14). As a result, it may be possible to eliminate such a possibility that the tapping sound of the password entered in the password input status is recorded in the HDD 50.

When the password input status determining unit 30 determines that the password input status ends (block ST15), the sound collecting unit 40 is brought into the original status namely turned on (block ST16).

Thereafter, the password input status determining unit 30 notifies that the sound collecting unit 40 is turned on, and then, the process operation is accomplished (block ST17).

As previously explained, According to the information processing apparatuses 1 and 1a and the control methods thereof related to the first and second embodiments, even if the sound generated when the password is entered by manipulating the keyboard 20 is recorded and analyzed, the tapping sound of the keyboard 20 may be hardly analyzed due to the disturbing effect achieved by the overlapped sound. As a result, it may be possible to avoid that the password is stolen.

Also, according to the information processing apparatus 1b related to the third embodiment, since the tapping sound of the password is not recorded in the information processing apparatus 1b, even if the information processing apparatus 1b is stolen, it may be possible to avoid that the password is stolen.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus comprising:
a status determining unit that determines whether or not the information processing apparatus is in a password input status allowing a user to input a password by a keyboard;
a sound generating unit that generates an overlap sound to be overlapped with a tapping sound of the keyboard when the status determining unit determines that the information processing apparatus is in the password input status; and
a sound output unit configured to externally output the overlap sound.

2. The information processing apparatus according to claim 1, wherein a frequency range of the overlap sound is overlapped with at least a part of a frequency range of the tapping sound of the keyboard.

3. The information processing apparatus according to claim 2, wherein the sound generating unit further generates a pleasant sound and overlaps the pleasant sound and the overlap sound with each other, and wherein the sound output unit outputs the overlap sound and pleasant sound overlapped with each other.

4. The information processing apparatus according to claim 1, further comprising a sound analyzing unit that analyzes the tapping sound of the keyboard, wherein the overlap sound is approximated to the tapping sound and is generated based on an analysis result of the sound analyzing unit.

5. The information processing apparatus according to claim 1, wherein the sound output unit is capable of ceasing to output the overlap sound in accordance with a user setting.

6. An information processing apparatus comprising:
a sound collecting unit configured to collect a sound; and
a status determining unit that determines a password input status allowing a user to input a password by a keyboard, wherein when the status determining unit determines that the information processing apparatus is in the password input status, the status determining unit causes the sound collecting unit to stop collecting the sound.

7. A control method of an information processing apparatus, the method comprising:
determining whether the information processing apparatus is in a password input status allowing a user to input a password by a keyboard;
generating an overlap sound to be overlapped with a tapping sound of the keyboard when it is determined that the information processing apparatus is in the password input status; and
outputting the overlap sound.

8. The control method according to claim 7, wherein a frequency range of the overlap sound is overlapped with at least a part of a frequency range of the tapping sound of the keyboard.

9. The control method according to claim 8,
wherein the generating step further generates a pleasant sound, and wherein the outputting step further outputs the pleasant sound together with the overlap sound.

10. The control method according to claim 7, further comprising analyzing the tapping sound of the keyboard, wherein the sound generated at the generating step is approximated to the tapping sound of the keyboard and is generated based on an analysis result at the analyzing step.

11. The control method according to claim 7, further comprising ceasing the outputting step in accordance with a user setting.

12. A control method of an information processing apparatus, the method comprising:
collecting a sound;
determining whether the information processing apparatus is in a password input status allowing a user to input a password by a keyboard; and
ceasing the collecting step when it is determined that the information processing apparatus is in the password input status.
